(19) United States
(12) Patent Application Publication
(10) Pub. No.: US 2010/0264679 A1
(43) Pub. Date: Oct. 21, 2010

(54) SUCTION HOLD HAND, SUCTION HOLD METHOD, AND CARRYING DEVICE

(75) Inventor: Tomonori MORIYA, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/762,502

(22) Filed: Apr. 19, 2010

(30) Foreign Application Priority Data
Apr. 21, 2009 (JP) 2009-102743

(51) Int. Cl. B25J 15/06

(52) U.S. Cl. 294/64.1

(57) ABSTRACT

A suction hold hand which sucks and holds a hold target without contact by using negative pressure produced at a central portion of turning flow of gas generated in a turning flow generating chamber and gas flowing from the end to the side of the turning flow generating chamber, includes: a suction pad having a suction hold surface to which a suction blowoff hole of the turning flow generating chamber opens; and a gas blowoff device which has a plurality of blowoff holes disposed to oppose to a sucked surface substantially continuous to a surface of the hold target sucked by the suction pad to face the suction hold surface, the blowoff holes being located in such positions as to apply compressed gas to the sucked surface.

### BACKGROUND

1. Technical Field

The present invention relates to a suction hold hand which sucks and holds a hold target, a suction hold method used for sucking and holding the hold target, and a carrying device which sucks and holds a carrying target for carrying the carrying target.

2. Related Art

In the field of a chucking method and a chucking device used in a step of processing a workpiece which includes minute structures precisely formed on a fragile material such as a semiconductor substrate on which plural semiconductor devices are formed, various techniques have been developed for preventing damage to a processed surface of the workpiece while the workpiece is being carried by the chucking device. For holding a hold target which has only a small surface area touchable by the chucking device, a holding method which uses Bernoulli chuck capable of chucking a hold target such as a workpiece without contact by application of Bernoulli's theorem has been adopted.

JP-A-11-254369 discloses a non-contact carrying device which has a turning chamber for generating turning airflow, and opposed surfaces communicating with the turning chamber and disposed to oppose to a carrying target to suck the carrying target without contact.

Moreover, JP-A-2008-87910 shows a non-contact carrying device which expands the hold range of a workpiece for the amount of air supply by improving the shape of the turning chamber such that the workpiece can be securely and stably held and carried.

According to the carrying devices disclosed in JP-A-11-254369 and JP-A-2008-87910, however, the flowing condition of compressed air supplied from the turning chamber is not kept uniform on the entire circumference of a hold end for holding (sucking) the hold target (carrying target or workpiece). In this case, the position of the hold target for the suction end surface of the hold end is difficult to be kept fixed. When the position of the hold target is varied and inclined to the suction end surface, the clearance between the suction end surface and the hold target is not securely maintained. As a result, the suction end surface and the hold target come into contact with each other in some cases.

### SUMMARY

It is an advantage of some aspects of the invention to provide a technology which solves at least a part of the problems described above.

### First Aspect

A first aspect of the invention is directed to a suction hold hand which sucks and holds a hold target without contact by using negative pressure produced at a central portion of turning flow of gas generated in a turning flow generating chamber and gas flowing from the end to the side of the turning flow generating chamber. The suction hold hand includes: a suction pad having a suction hold surface to which a suction blowoff hole of the turning flow generating chamber opens; and a gas blowoff device which has a plurality of blowoff holes disposed to oppose to a sucked surface substantially continuous to a surface of the hold target sucked by the suction pad to face the suction hold surface, the blowoff holes being located in such positions as to apply compressed gas to the sucked surface.

According to this suction hold hand, compressed gas can be applied to the sucked surface of the hold target sucked by the suction pad to face the suction hold surface by actuating the gas blowoff device having the plural blowoff holes.

A Bernoulli chuck based on Bernoulli's theorem like this suction hold hand sucks the hold target by using negative pressure produced at the central portion of the turning flow of the gas generated in the turning flow generating chamber. The gas in the turning flow generating chamber flowing from the suction blowoff hole open to the suction hold surface gives a force acting on the sucked surface in a direction of separating the hold target from the suction hold surface. Thus, non-contact condition is produced between the sucked hold target and the suction hold surface.

Since the force in the direction of separating the hold target from the suction hold surface is given to the sucked surface by applying the compressed gas to the sucked surface of the hold target by the function of the gas blowoff device, the non-contact condition between the hold target and the suction hold surface can be more securely maintained. The gas flowing from the suction blowoff hole after turning within the turning flow generating chamber as turning flow does not necessarily flow out in a constant condition throughout the circumference of the suction blowoff hole. The variations in the condition of the gas flowing from the suction blowoff hole in the circumferential direction of the suction blowoff hole vary the position of the hold target with respect to the suction hold surface. However, the gas applied by the gas blowoff device can be easily maintained at constant pressure. Accordingly, the position of the hold target with respect to the suction hold surface can be kept constant, and thus the non-contact condition between the hold target and the suction hold surface can be more securely maintained.

### Second Aspect

A second aspect of the invention is directed to the suction hold hand of the above aspect, wherein the gas blowoff device has a flow amount control valve which can control each of the flow amounts of the gas supplied to the plural blowoff holes.

According to this suction hold hand, the amount of the compressed gas applied to the sucked surface of the hold target is controlled by adjusting the flow amounts of the gas supplied to the blowoff holes using the flow amount control valve. By this method, a force for pressing the sucked surface generated by the compressed gas applied to the sucked surface is controlled such that the distance between the hold target and the suction hold surface can be adjusted to an appropriate size.

### Third Aspect

A third aspect of the invention is directed to the suction hold hand of the above aspects, wherein: the gas blowoff device has three or more of the blowoff holes; and three or more of the blowoff holes are disposed in such positions that the center of the suction blowoff hole is positioned inside a polygon formed by connecting the centers of the blowoff holes.

According to this suction hold hand, the suction blowoff hole is located inside the polygon formed by connecting the centers of the blowoff holes. In this case, the point of application of the suction force given from the suction blowoff hole is also positioned inside the polygon formed by connecting the centers of the blowoff holes. Similarly, the point of application of the combined pressing force produced by the gas supplied from the blowoff holes is positioned inside the polygon formed by connecting the centers of the blowoff holes. Since the points of application of the suction force and the pressing force acting on the hold target are close to each other, the moment produced by the positional difference between the suction force and the pressing force is small. Accordingly, inclination of the sucked surface of the hold target to the suction hold surface of the suction hold hand can be reduced.

### Fourth Aspect

A fourth aspect of the invention is directed to the suction hold hand of the above aspects which further includes a measuring unit which measures the distance between a part of the hold target and the suction hold surface.

According to this suction hold hand, the distance between the suction hold surface and the hold target can be measured by the measuring unit. Thus, the position of the hold target such as its inclination to the suction hold surface can be detected by measuring the distances between a plurality of parts of the hold target and the suction hold surface.

### Fifth Aspect

A fifth aspect of the invention is directed to the suction hold hand of the above aspects which further includes a flow amount balance control unit which separately adjusts each of the flow amounts of the gas supplied to the blowoff holes by controlling the flow amount control valve according to the distance between each part of the hold target and the suction hold surface measured by the measuring unit.

According to this suction hold hand, each of the flow amounts supplied to the blowoff holes is adjusted by controlling the flow amount control valve. Thus, the amount of the compressed air applied to the sucked surface of the hold target can be controlled for each of the parts of the hold target. By this method, the position of the hold target with respect to the suction hold surface can be controlled by adjusting the force for pressing the sucked surface generated by the compressed gas applied to the sucked surface for each of the parts of the hold target. In this case, the position of the hold target with respect to the suction hold surface can be adjusted in such a manner as to become a desired position such as a position parallel with the suction hold surface by controlling the flow amount control valve using the flow amount balance control unit according to the distance between the suction hold surface and each part of the hold target measured by the measuring unit.

### Sixth Aspect

A sixth aspect of the invention is directed to a suction hold method which sucks and holds a hold target without contact via a suction pad having a suction hold surface by using negative pressure produced at a central portion of turning flow of gas generated in a turning flow generating chamber and gas flowing from a suction blowoff hole of the turning flow generating chamber to the suction hold surface to which the suction blowoff hole opens. The method includes: a flow supplying step for supplying compressed gas to a plurality of blowoff holes of a gas blowoff device, and the blowoff holes are disposed to oppose to a sucked surface substantially continuous to a surface of the hold target, to apply the compressed gas to the sucked surface when the hold target is sucked and held by the suction pad and positioned in such a position as to face the suction hold surface; and a sucking step for sucking the hold target toward the suction hold surface by supplying the compressed gas to the turning flow generating chamber.

According to the suction hold method, compressed gas can be applied to the sucked surface of the hold target sucked by the suction pad to face the suction hold surface by actuating the gas blowoff device having the plural blowoff holes in the flow supplying step.

The suction hold device used in the sucking step sucks the hold target by using the negative pressure produced at the central portion of the turning flow of the gas generated in the turning flow generating chamber. The gas in the turning flow generating chamber flowing from the suction blowoff hole open to the suction hold surface gives a force acting on the sucked surface in a direction of separating the hold target from the suction hold surface. Thus, non-contact condition is produced between the sucked hold target and the suction hold surface.

Since the force in the direction of separating the hold target from the suction hold surface is given to the sucked surface by applying the compressed gas to the sucked surface of the hold target using the gas blowoff device in the flow supplying step, the non-contact condition between the hold target and the suction hold surface can be more securely maintained. The gas flowing from the suction blowoff hole after turning within the turning flow generating chamber as turning flow does not necessarily flow out in a constant condition throughout the circumference of the suction blowoff hole. The variations in the condition of the gas flowing from the suction blowoff hole in the circumferential direction of the suction blowoff hole vary the position of the hold target with respect to the suction hold surface. However, the gas applied by the gas blowoff device can be easily maintained at constant pressure. Accordingly, the position of the hold target with respect to the suction hold surface can be kept constant, and thus the non-contact condition between the hold target and the suction hold surface can be more securely maintained.

### Seventh Aspect

A seventh aspect of the invention is directed to the suction hold method of the above aspect which further includes a gas flow amount controlling step for controlling the flow amount of the compressed gas applied to the sucked surface.

According to this suction hold method, the flow amount of the compressed gas applied to the sucked surface is controlled in the gas flow amount controlling step. Thus, the distance between the sucked surface of the hold target and the suction hold surface can be controlled by adjusting the force for pressing the sucked surface generated by the compressed gas applied to the sucked surface.

### Eighth Aspect

An eighth aspect of the invention is directed to the suction hold method of the above aspects, wherein: the gas blowoff device has three or more of the blowoff holes; and three or more of the blowoff holes are disposed in such positions that the center of the suction blowoff hole is positioned inside a polygon formed by connecting the centers of the blowoff holes.

According to this suction hold method, the suction blowoff hole is located inside the polygon formed by connecting the centers of the blowoff holes. In this case, the point of application of the suction force given from the suction blowoff hole is also positioned inside the polygon formed by connecting the centers of the blowoff holes. Similarly, the point of application of the combined pressing force produced by the gas supplied from the blowoff holes is positioned inside of the polygon formed by connecting the centers of the blowoff holes. Since the points of application of the suction force and the pressing force acting on the hold target are close to each other, the moment produced by the positional difference between the suction force and the pressing force is small. Accordingly, inclination of the sucked surface of the hold target to the suction hold surface of the suction hold hand can be reduced.

### Ninth Aspect

A ninth aspect of the invention is directed to the suction hold method of the above aspects which further includes a height measuring step for measuring the distance between a part of the hold target and the suction blowoff hole.

According to this suction hold method, the distance between the suction hold surface and the sucked surface of the hold target can be measured by the height measuring step. Moreover, the position of the hold target such as its inclination to the suction hold surface can be detected by measuring the distances between a plurality of parts of the hold target and the suction hold surface.

### Tenth Aspect

A tenth aspect of the invention is directed to the suction hold method of the above aspects which further includes a flow amount balance controlling step for separately adjusting each of the flow amounts of the gas supplied to the blowoff holes according to the distance between each part of the hold target and the suction hold surface measured in the height measuring step.

According to this suction hold method, each of the flow amounts of the compressed gas supplied to the sucked surface of the hold target is adjusted for each part of the hold target by separately controlling each flow amount of the gas supplied to the blowoff holes in the gas flow amount controlling step. Thus, the amount of the compressed gas applied to the sucked surface of the hold target can be controlled for each of the parts of the hold target. By this method, the position of the hold target with respect to the suction hold surface can be controlled by adjusting the force for pressing the sucked surface generated by the compressed gas applied to the sucked surface for each of the parts of the hold target. In this case, the position of the hold target with respect to the suction hold surface can be adjusted in such a manner as to become a desired position such as a position parallel with the suction hold surface by controlling the flow amount of the gas in the flow amount balance controlling step according to the distances between the suction hold surface and each part of the hold target measured in the height measuring step.

### Eleventh Aspect

An eleventh aspect of the invention is directed to a carrying device which includes a holding unit which sucks and holds a carrying target without contact by using negative pressure produced at a central portion of turning flow of gas generated in a turning flow generating chamber and gas flowing from the end to the side of the turning flow generating chamber such that the carrying target held by the holding unit can be carried. The holding unit includes: a suction pad having a suction hold surface to which a suction blowoff hole of the turning flow generating chamber opens; and a gas blowoff device which has a plurality of blowoff holes disposed to oppose to a sucked surface substantially continuous to a surface of the carrying target sucked by the suction pad to face the suction hold surface, the blowoff holes being located in such positions as to apply compressed gas to the sucked surface.

According to this carrying device, compressed gas can be applied to the sucked surface of the carrying target sucked by the suction pad to face the suction hold surface by actuating the gas blowoff device having the plural blowoff holes.

The holding unit which uses a suction force produced by the negative pressure generated at the central portion of the turning flow of the gas sucks the carrying target by using the negative pressure produced at the central portion of the turning flow of the gas generated in the turning flow generating chamber. The gas in the turning flow generating chamber flowing from the suction blowoff hole open to the suction hold surface gives a force acting on the sucked surface in a direction of separating the carrying target from the suction hold surface. Thus, non-contact condition is produced between the sucked carrying target and the suction hold surface.

Since the force in the direction of separating the carrying target from the suction hold surface is given to the sucked surface by applying the compressed gas to the sucked surface of the carrying target by the function of the gas blowoff device, the non-contact condition between the carrying target and the suction hold surface can be more securely maintained. The gas flowing from the suction blowoff hole after turning within the turning flow generating chamber as turning flow does not necessarily flow out in a constant condition throughout the circumference of the suction blowoff hole. The variations in the condition of the gas flowing from the suction blowoff hole in the circumferential direction of the suction blowoff hole vary the position of the carrying target with respect to the suction hold surface. However, the gas applied by the gas blowoff device can be easily maintained at constant pressure. Accordingly, the position of the carrying target with respect to the suction hold surface can be kept constant, and thus the non-contact condition between the carrying target and the suction hold surface can be more securely maintained.

### Twelfth Aspect

A twelfth aspect of the invention is directed to the carrying device of the above aspect, wherein the gas blowoff device has a flow amount control valve which can control each of the flow amounts of the gas supplied to the plural blowoff holes.

According to this carrying device, the amount of the compressed gas applied to the sucked surface of the carrying target can be controlled by adjusting the flow amounts of the gas supplied to the blowoff holes using the flow amount control valve. Thus, the distance between the carrying target and the suction hold surface can be controlled by adjusting a force for pressing the sucked surface generated by the compressed gas applied to the sucked surface.

### Thirteenth Aspect

A thirteenth aspect of the invention is directed to the carrying device of the above aspects, wherein: the gas blowoff device has three or more of the blowoff holes; and three or more of the blowoff holes are disposed in such positions that the center of the suction blowoff hole is positioned inside a polygon formed by connecting the centers of the blowoff holes.

According to this carrying device, the suction blowoff hole is located inside the polygon formed by connecting the centers of the blowoff holes. In this case, the point of application of the suction force given from the suction blowoff hole is also positioned inside the polygon formed by connecting the centers of the blowoff holes. Similarly, the point of application of the combined pressing force produced by the gas supplied from the blowoff holes is positioned inside the polygon formed by connecting the centers of the blowoff holes. Therefore, since the points of application of the suction force and the pressing force acting on the carrying target are close to each other, the moment produced by the positional difference between the suction force and the pressing force is small. Accordingly, inclination of the sucked surface of the carrying target to the suction hold surface of the suction hold hand can be reduced.

### Fourteenth Aspect

A fourteenth aspect of the invention is directed to the carrying device of the above aspects which further includes a measuring unit which measures the distance between a part of the carrying target and the suction hold surface.

According to this carrying device, the distance between the suction hold surface and the carrying target can be measured by the measuring unit. Thus, the position of the carrying target such as its inclination to the suction hold surface can be detected by measuring the distances between a plurality of parts of the carrying target and the suction hold surface.

### Fifteenth Aspect

A fifteenth aspect of the invention is directed to the carrying device of the above aspects which further includes a flow amount balance control unit which separately adjusts each of the flow amounts of the gas supplied to the blowoff holes by controlling the flow amount control valve according to the distance between each part of the carrying target and the suction hold surface measured by the measuring unit.

According to this carrying device, each of the flow amounts supplied to the blowoff holes is adjusted by controlling the flow amount control valve. Thus, the amount of the compressed air applied to the sucked surface of the carrying target can be controlled for each of the parts of the carrying target. By this method, the position of the carrying target with respect to the suction hold surface can be controlled by adjusting the force for pressing the sucked surface generated by the compressed gas applied to the sucked surface for each of the parts of the carrying target. In this case, the position of the carrying target with respect to the suction hold surface can be adjusted in such a manner as to become a desired position such as a position parallel with the suction hold surface by controlling the flow amount control valve using the flow amount balance control unit according to the distance between the suction hold surface and each part of the carrying target measured by the measuring unit.

### Sixteenth Aspect

A sixteenth aspect of the invention is directed to the carrying device of the above aspects, wherein the measuring unit is formed integrally with the suction pad of the holding unit.

According to this carrying device, the measuring unit is formed integrally with the suction pad. Thus, the positional relationship between the measuring unit and the suction pad is fixed. Accordingly, the distance between the sucked surface of the carrying target and the suction hold surface can be detected by measuring the distance between the measuring unit and the sucked surface using the measuring unit.

### Seventeenth Aspect

A seventeenth aspect of the invention is directed to the carrying device of the above aspects, wherein the measuring unit is fixed separately from the suction pad of the holding unit.

According to this carrying device, the measuring unit is provided as a separate and independent component from the holding unit. Thus, limitations such as the structure and the size of the measuring unit imposed when the measuring unit is formed integrally with the suction pad do not increase.

### BRIEF DESCRIPTION OF THE DRAWINGS

The invention will be described with reference to the accompanying drawings, wherein like numbers reference like elements.

FIG. 1A is a plan view of an example of an SAW resonance piece.

FIG. 1B is a plan view of a resonance piece wafer on which a plurality of SAW patterns are formed.

FIG. 2 is a perspective view illustrating the external appearance of the general structure of a work feeding and removing device.

FIG. 3 is a perspective view illustrating the structure of a suction pad.

FIG. 4 is a plan view illustrating the structure of a head case.

FIG. 5A is a cross-sectional view illustrating a condition in which the suction pads are attached to the head case.

FIG. 5B is a plan view illustrating the condition in which the suction pads are attached to the head case as viewed from the suction pads.

FIG. 6 is a perspective view illustrating the disassembled general structure of a suction hold hand.

FIG. 7 is a perspective view illustrating the external appearance of the general structure of a pad holder and its surroundings of a suction hold hand.

### DESCRIPTION OF EXEMPLARY EMBODIMENT

A suction hold hand, a suction hold method, and a carrying device according to an embodiment of the invention are hereinafter described with reference to the drawings. In this embodiment, a work feeding and removing device will be discussed as an example of a carrying device. The work feeding and removing device in this embodiment handles a resonance piece wafer on which a plurality of SAW (surface acoustic wave) patterns constituting an SAW resonance piece are formed in respective sections in a step for manufacturing an SAW resonator. In the drawings referred to in the following explanation, the reduction scales of components and parts in the vertical and horizontal directions and the reduction scales for the individual parts are different from the practical scales in some cases for easy understanding of the structural components.

### Resonance Piece Wafer

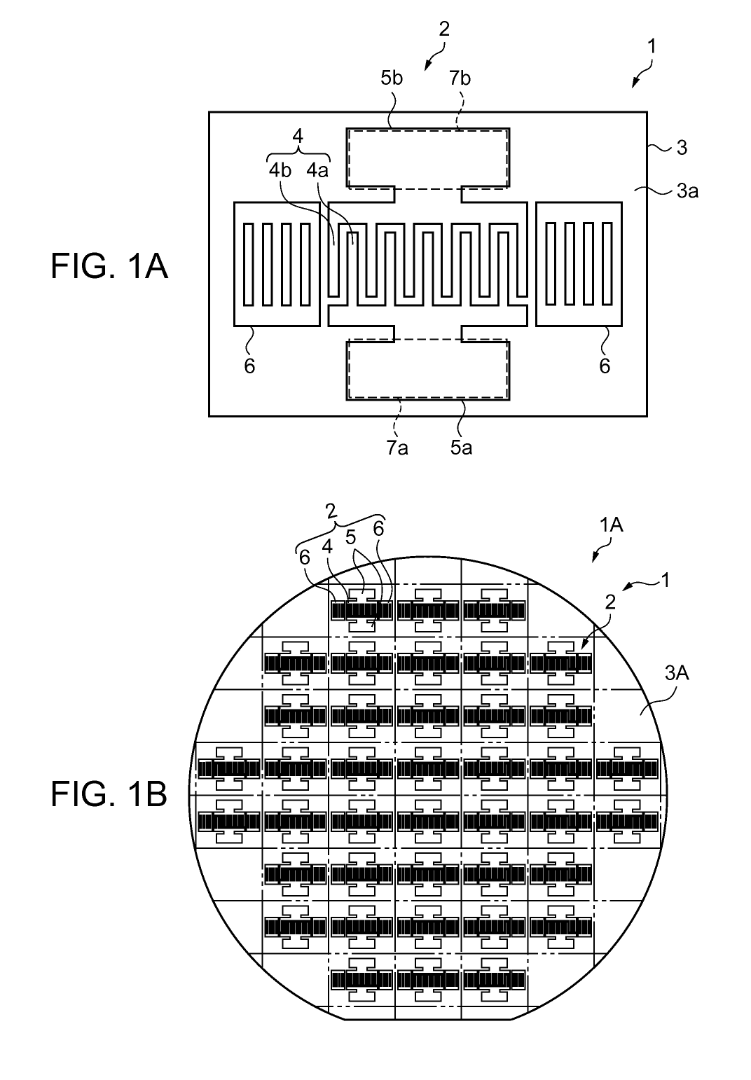

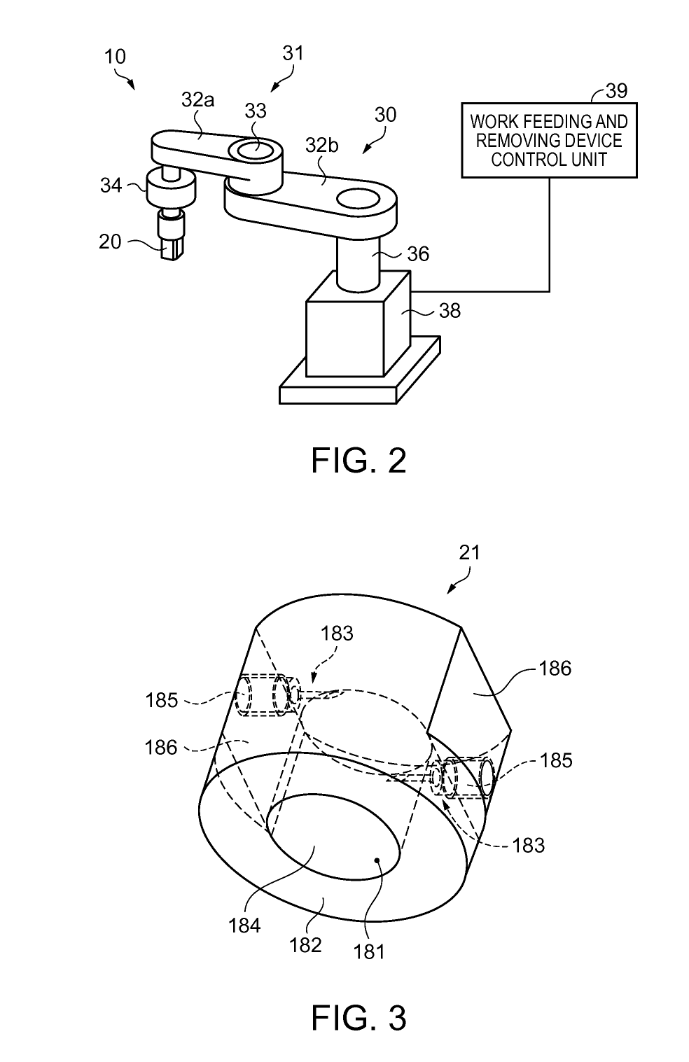

Initially, a resonance piece wafer 1A as an example of a carrying target or a hold target handled by a work feeding and removing device 10 (see FIG. 2) is explained with reference to FIGS. 1A and 1B. The resonance piece wafer 1A has SAW resonance pieces 1 formed on a piezoelectric wafer in respective sections. Each of the SAW resonance pieces 1 is a chief element constituting the SAW resonator. FIG. 1A is a plan view illustrating an example of the SAW resonance piece. FIG. 1B is a plan view illustrating a resonance piece wafer on which a plurality of SAW patterns are formed.

The SAW resonator is produced by sealing the SAW resonance pieces 1 within a housing, bonding the SAW resonance pieces 1 thereto, and connecting the SAW resonance pieces 1 with housing terminals by bonding wires such that continuity therebetween can be provided.

As illustrated in FIG. 1A, each of the SAW resonance pieces 1 has a base (chip) formed by cutting a piezoelectric body such as crystal, lithium tantalate, and lithium niobate into a rectangular shape. A chip 3 made of piezoelectric body in this embodiment is a component cut into a substantially flat rectangular shape, and has an inter digital transducer (IDT) 4 containing a pair of an electrode 4a and an electrode 4b at the center of a surface (main surface) 3a of the chip 3. A grid-shaped reflector 6 is provided on each side of the IDT 4 in the longitudinal direction. A bonding land 5a and a bonding land 5b connected with the electrode 4a and the electrode 4b of the IDT 4 for continuity, respectively, are provided along the edge of the chip 3 in the longitudinal direction. The bonding land 5a and the bonding land 5b are made of the same materials as those of the electrode 4a and the electrode 4b such that electric connection can be achieved by wire bonding to the bonding land 5a and the bonding land 5b. A set of the IDT 4, the reflectors 6, and the bonding lands 5a and 5b are referred to as an SAW pattern 2.

Areas 7a and 7b indicated by broken lines in FIG. 1A are areas where anodized resist film is formed. Anodized film formed on the surfaces of electrodes by anodizing the surfaces of the electrodes protects the electrodes while scarcely affecting the characteristics of the SAW resonance piece 1 so as to prevent troubles caused by foreign materials adhering to the electrodes. The anodized resist film is resist film for preventing formation of the anodized film on the bonding lands 5a and 5b.

As illustrated in FIG. 1B, the resonance piece wafer 1A contains a plurality of the SAW patterns 2 formed on a wafer 3A made of piezoelectric body. The resonance piece wafer 1A is anodized after the plural SAW patterns 2 are formed on the resonance piece wafer 1A. In this embodiment, the resonance piece wafer 1A is expressed in the same manner as “resonance piece wafer 1A” both before anodization and after anodization. For feeding the resonance piece wafer 1A to an anodizing device and removing the resonance piece wafer 1A after coated with the anodized film from the anodizing device, the surface of the resonance piece wafer 1A provided with the SAW patterns 2 or the surface of the resonance piece wafer 1A coated with the anodized film is required to be held. Thus, such a holding method which does not affect the SAW patterns 2 nor the anodized film needs to be adopted.

### Work Feeding and Removing Device

The work feeding and removing device 10 is now explained with reference to FIG. 2. FIG. 2 is a perspective view illustrating the external appearance of the general structure of the work feeding and removing device 10.

As illustrated in FIG. 2, the work feeding and removing device 10 includes a robot mechanism 30 having a suction hold hand 20, a work feeding and removing arm 31, and a machine stand 38, and a work feeding and removing device control unit 39.

The work feeding and removing arm 31 has an arm 32a, an arm 32b, an arm joint 33, a hand hold mechanism 34, and an arm shaft 36. An end of the arm 32a and an end of the arm 32b are connected with each other by the arm joint 33. The end of the arm 32b opposite to the end connected with the arm joint 33 is connected with the arm shaft 36. The arm shaft 36 holds the arm 32b such that the arm 32b can rotate around the rotation shaft of the arm shaft 36. The arm 32b holds the arm 32a via the arm joint 33 such that the arm 32a can rotate around the rotation shaft of the arm joint 33. The angle formed by the arms 32a and 32b can be controlled at the arm joint 33. That is, the work feeding and removing arm 31 can expand and contract at the arm joint 33. The axial direction of the rotation shaft of the arm shaft 36 and the axial direction of the rotation shaft of the arm joint 33 extend substantially in parallel with each other. The machine stand 38 supports the arm shaft 36 via a sliding support mechanism (not shown) contained in the machine stand 38 such that the arm shaft 36 can freely slide in the axial direction of the rotation shaft of the arm shaft 36 and can be precisely positioned and fixed.

The hand hold mechanism 34 is fixed to the end of the arm 32a on the side opposite to the end connected with the arm joint 33. The suction hold hand 20 is fixed to the hand hold mechanism 34. The hand hold mechanism 34 has a rotation shaft extending in the same axial direction as those of the rotation axes of the arm shaft 36 and of the arm joint 33, and supports the suction hold hand 20 such that the suction hold hand 20 can rotate around the rotation shaft of the arm 32a.

The suction hold hand 20 has four suction pads 21 which will be described later (see FIG. 3). Thus, the suction hold surface of the suction hold hand 20 is constituted by four suction hold surfaces 182 of the four suction pads 21 (see FIG. 3). The suction hold surface of the suction hold hand 20 is substantially perpendicular to the rotation shaft of the hand hold mechanism 34. The direction of the suction hold surface within a planar direction parallel with the suction hold surface can be varied by rotating the suction hold hand 20 using the hand hold mechanism 34.

The work feeding and removing device control unit 39 supervises and controls the operations of the respective components of the work feeding and removing device 10 under a control program inputted via an information input/output device (not shown) in advance.

The operation of the work feeding and removing device 10 for carrying a workpiece is now explained.

Initially, the suction hold hand 20 is disposed at an arbitrary position such as a position for sucking and holding the workpiece by rotating the work feeding and removing arm 31 by the function of the arm shaft 36 to locate the work feeding and removing arm 31 in an arbitrary direction, and expanding or contracting the work feeding and removing arm 31 at the arm joint 33. Then, the arm shaft 36 is slidingly moved in the axial direction of the rotation shaft of the arm shaft 36 by the function of the sliding support mechanism of the machine stand 38 to shift the suction hold surface of the suction hold hand 20 close enough to the workpiece to suck and hold the workpiece, and the workpiece is sucked and held at that position. Subsequently, the arm shaft 36 is again slidingly moved by the sliding support mechanism of the machine stand 38 to shift the suction hold hand 20 and thereby raise the workpiece in accordance with the movement of the suction hold hand 20.

Then, the work feeding and removing arm 31 is rotated by the arm shaft 36 to locate the work feeding and removing arm 31 in a direction where the workpiece is to be carried. After rotated, the work feeding and removing arm 31 is expanded and contracted at the arm joint 33 to dispose the suction hold hand 20 sucking and holding the workpiece at such a position where the workpiece can face a carrying position. Then, the arm shaft 36 is slidingly moved in the axial direction of the rotation shaft of the arm shaft 36 by the function of the sliding support mechanism of the machine stand 38 to shift the workpiece sucked and held by the suction hold hand 20 close enough to the carrying surface to place the workpiece on the carrying surface. Subsequently, the sucked and held condition of the workpiece is released at that position, and thus the workpiece drops on the carrying surface. The workpiece such as the resonance piece wafer 1A carried by the work feeding and removing device 10 corresponds to a hold target or a carrying target.

### Suction Pad

The suction pads 21 provided on the suction hold hand 20 are now explained with reference to FIG. 3. The suction pads 21 suck a workpiece to be sucked and held based on application of Bernoulli's theorem, and maintain non-contact condition between the workpiece and the suction pads by applying pressing force against the workpiece using gas flowing out of the suction pads 21 to hold the workpiece without contact. FIG. 3 is a perspective view illustrating the structure of one of the suction pads 21.

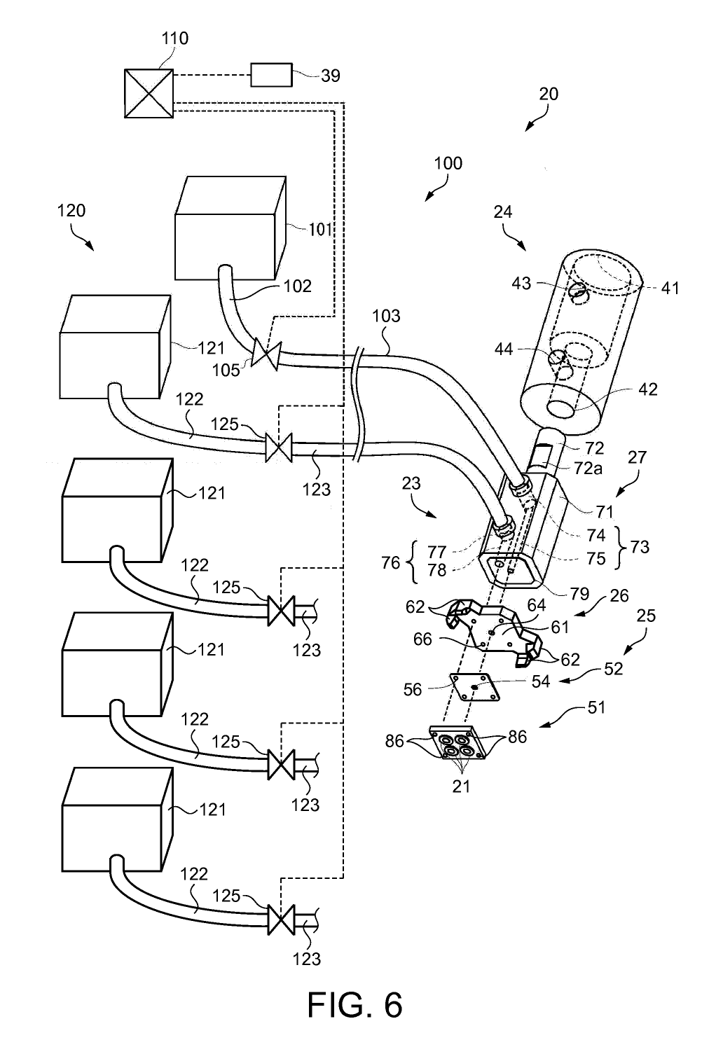

As illustrated in FIG. 3, the suction pad 21 includes a turning flow generating chamber 181, the suction hold surface 182, a pair of injection gas flow paths 183, 183, and a pair of chamber flow paths 185, 185. The turning flow generating chamber 181 is a cylindrical concave. The suction hold surface 182 is an end surface to which the turning flow generating chamber 181 of the suction pad 21 opens. The suction hold surface 182 is a surface connecting with the open end of the turning flow generating chamber 181 and facing the suction target workpiece in the sucked and held condition. One end of each of the injection gas flow paths 183 opens to an inner circumferential surface 184 of the turning flow generating chamber 181 and injects compressed air into the turning flow generating chamber 181 to generate turning flow within the turning flow generating chamber 181. The chamber flow paths 185 communicate with the corresponding upstream ends of the injection gas flow paths 183 to supply compressed air from a suction gas supply unit 100 (see FIG. 6). The compressed air supplied from the suction gas supply unit 100 simultaneously flows into the pair of the chamber flow paths 185, and then passes the respective injection gas flow paths 183 to be injected into the turning flow generating chamber 181.

The external shape of the suction pad 21 is a substantially cylindrical shape having the approximately circular suction hold surface 182 as the end surface. A part of the area of the suction pad 21 from the intermediate position of the cylindrical shape to the end surface opposite to the suction hold surface 182 is cut off. The cut portion has flat surfaces constituted by a pair of surfaces 186, 186 parallel with each other. Each side of the chamber flow paths 185 opposite to the side communicating with the injection gas flow path 183 opens to the surface 186.

The turning flow generating chamber 181 as a cylindrical portion has the inner circumferential surface 184 whose one end is closed. A pair of the injection gas flow paths 183 are provided on the closed side of the turning flow generating chamber 181. Compressed air having entered the turning flow generating chamber 181 flows along the inner circumferential surface 184, and becomes strong turning flow. Then, the compressed air flows from the opened end toward the side. Negative pressure is generated at the central portion of the turning flow based on the Bernoulli's theorem, and the workpiece such as the resonance piece wafer 1A is sucked by the negative pressure.

The suction hold surface 182 connects with the open end of the turning flow generating chamber 181, and has a shape crossing the turning axis of the turning flow approximately at right angles. When reaching the open end of the turning flow generating chamber 181, the turning flow generated within the turning flow generating chamber 181 flows from the inner circumferential side to the outer circumferential side along the suction hold surface 182 as vortex flow due to the centrifugal force of the turning flow. The air flowing from the turning flow generating chamber 181 along the suction hold surface 182 maintains the clearance between the workpiece such as the resonance piece wafer 1A and the suction hold surface 182.

According to the suction pad 21 shown in FIG. 3, the turning flow generated within the turning flow generating chamber 181 turns clockwise as viewed from the suction hold surface 182. When the injection gas flow paths 183 are shifted to symmetric positions with respect to a surface containing the center axis of the turning flow generating chamber 181, the turning flow generated within the turning flow generating chamber 181 turns anticlockwise as viewed from the suction hold surface 182. In this embodiment, any suction pad generating turning flow in either direction is expressed as “suction pad 21” regardless of the turning direction.

The shape of the suction pad 21 may be a bell-mouth shape including the turning flow generating chamber 181 whose open end gradually expands, or a shape including the suction hold surface 182 which has a vortex-shaped groove capable of maintaining vortex flow.

### Head Case

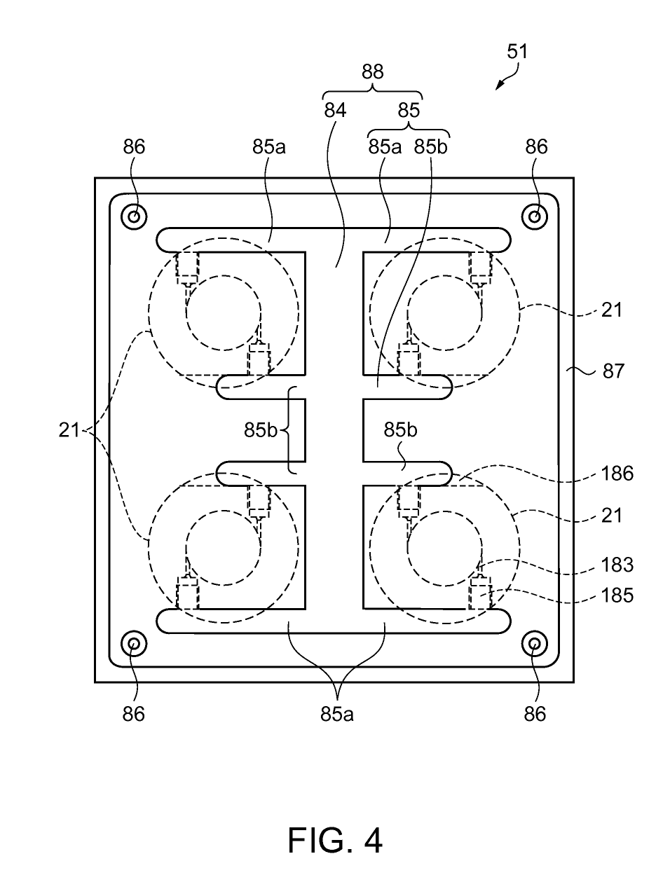

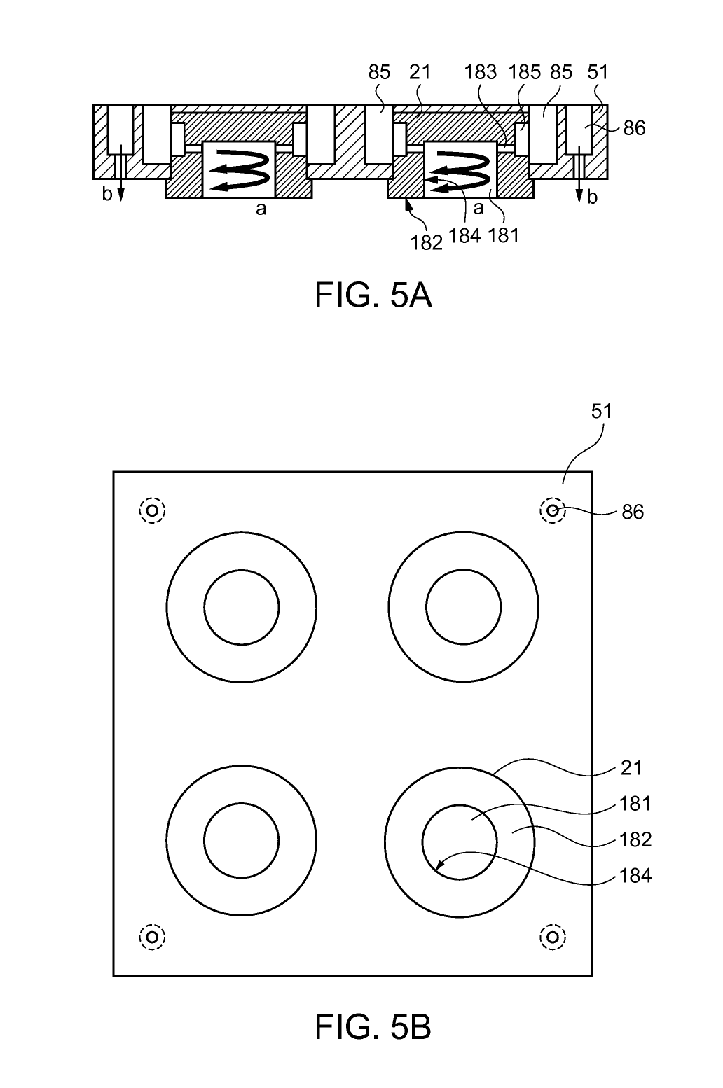

A head case 51 included in a suction hold head 25 (see FIG. 6) as a component to which the suction pads 21 are fixed is now explained with reference to FIG. 4 and FIGS. 5A and 5B. FIG. 4 is a plan view illustrating the structure of the head case 51. FIGS. 5A and 5B show conditions of the head case 51 to which the suction pads 21 are attached. FIG. 5A is a cross-sectional view illustrating the condition of the head case 51 to which the suction pads 21 are attached. FIG. 5B is a plan view illustrating the condition of the head case 51 to which the suction pads 21 are attached.

As illustrated in FIG. 4 and FIGS. 5A and 5B, the head case 51 holds the four suction pads 21 such that the suction pads 21 project downward and that the ends of the respective turning flow generating chambers 181 can be positioned within the same plane. More specifically, the head case 51 has four fixing holes in matrix. Each of the fixing holes has a flat surface capable of engaging with a pair of the surfaces 186, 186 of the suction pad 21 without clearance. Each of the suction pads 21 is bonded by engagement between the portions of the suction pad 21 corresponding to the surfaces 186 and the fixing hole. Concerning the turning directions of the turning flow generated by the suction pads 21, the four suction pads 21 are positioned such that the diagonally located two suction pads 21 generate turning flow in the clockwise direction, and that the other two diagonally located suction pads 21 generate turning flow in the anticlockwise direction.

As illustrated in FIG. 4, a compressed air groove 88 includes a wide main compressed air groove 84 so disposed as to divide the four suction pads 21 into two sections, and four sets of narrow sub compressed air grooves 85 each set of which is perpendicularly branched from the main compressed air groove 84 toward the corresponding suction pad 21. Each set of the sub compressed air grooves 85 is constituted by a long sub compressed air groove 85a and a short sub compressed air groove 85b and disposed at such positions that the attached suction pad 21 is sandwiched between the long and short sub compressed air grooves 85a and 85b. When the suction pads 21 are attached to the head case 51, each pair of the long sub compressed air groove 85a and the short sub compressed air groove 85b communicate with the corresponding chamber flow paths 185 open to the surface 186 of the suction pad 21. Compressed air supplied from the suction gas supply unit 100 described later (see FIG. 6) flows from a suction gas hole 54 of a cover case 52 described later (see FIG. 6) into each of the suction pads 21 via the corresponding main compressed air groove 84 and sub compressed air grooves 85. The compressed air having entered the suction pad 21 is injected into the turning flow generating chamber 181 to generate turning flow turning in a manner indicated by an arrow a in FIG. 5A. The cover case 52 is positioned with respect to the head case 51 by engaging with the inside of a projecting frame 87 formed on the periphery of the head case 51.

As illustrated in FIG. 4 and FIGS. 5A and 5B, four blowoff holes 86 are provided at the four corners of the head case 51. Each of the blowoff holes 86 is a stepped hole having a smaller area on the side of the outer surface of the head case 51 (the surface on the side engaging with the suction pad 21). Compressed air supplied from a blowoff gas supply unit 120 described later (see FIG. 6) flows from blowoff gas holes 56 of the cover case 52 described later (see FIG. 6), and blows off through the outer surface as indicated by an arrow b in FIG. 5A.

### Suction Hold Hand

The general structure of the suction hold hand 20 is now explained with reference to FIG. 6. FIG. 6 is a perspective view illustrating the disassembled general structure of the suction hold hand 20.

As illustrated in FIG. 6, the suction hold hand 20 includes the plural (four in the figure) suction pads 21 for sucking and holding a workpiece such as the resonance piece wafer 1A, a pad holder 23 for holding the suction pads 21, and a device attachment unit 24 for supporting the pad holder 23. The suction hold hand 20 further includes the suction gas supply unit 100 for supplying air for non-contact hold, the blowoff gas supply unit 120 for supplying blowoff air, and a suction hold control unit 110 for controlling the suction gas supply unit 100 and the blowoff gas supply unit 120 and linking with the work feeding and removing device control unit 39.

The pad holder 23 has the suction hold head 25 having the head case 51 discussed above, a work guide 26 for supporting the suction hold head 25 in the vertical direction, and a joint member 27 for supporting the work guide 26 in the vertical direction, all of which components 25, 26, and 27 are coaxially stacked.

The suction hold head 25 has the head case 51 and the cover case 52. The cover case 52 engages with the inside of the projecting frame 87 formed on the periphery of the head case 51 to be fixed thereto without clearance. When the cover case 52 is fixed to the head case 51, the main compressed air groove 84 and the sub compressed air grooves 85 formed on the head case 51 become a gas flow path communicating with the suction gas hole 54 formed on the cover case 52 and the chamber flow paths 185 formed on the suction pads 21. The blowoff gas holes 56 formed on the cover case 52 become gas flow paths communicating with the blowoff holes 86 formed on the head case 51.

The suction gas supply unit 100 includes a suction gas supply source 101, a suction gas supply pipe 102, a suction flow amount control valve 105, and a suction gas supply pipe 103. The suction gas supply source 101 is a device for supplying compressed air such as a compressed air pump. The suction flow amount control valve 105 has a flow path for compressed air, and a valve provided at an intermediate position of the flow path and capable of opening and closing the flow path and controlling the flow amount of compressed air. One end of the suction gas supply pipe 102 connects with the suction gas supply source 101, and the other end of the suction gas supply pipe 102 connects with one side of the flow path of the suction flow amount control valve 105. The other side of the suction flow amount control valve 105 connected with or cut from the flow path by the valve connects with one end of the suction gas supply pipe 103. The other end of the suction gas supply pipe 103 connects with a suction gas supply flow path 73 provided on the joint member 27 of the pad holder 23.

The open/close drive source of the suction flow amount control valve 105 is electrically connected with the suction hold control unit 110. The suction hold control unit 110 is electrically connected with the work feeding and removing device control unit 39. The suction hold control unit 110 controls the open/close drive source according to control signals received from the work feeding and removing device control unit 39 to achieve control over supply, stop, and supply amount adjustment of the suction gas by the suction flow amount control valve 105.

The blowoff gas supply unit 120 includes a blowoff gas supply source 121, a blowoff gas supply pipe 122, a blowoff flow amount control valve 125, and a blowoff gas supply pipe 123. The blowoff gas supply unit 120 is a device for supplying compressed air such as a compressed air pump. The blowoff flow amount control valve 125 has a flow path for compressed air, and a valve provided at an intermediate position of the flow path and capable of opening and closing the flow path and controlling the flow amount of compressed air.

One end of the blowoff gas supply pipe 122 connects with the blowoff gas supply source 121, and the other end of the blowoff gas supply pipe 122 connects with one side of the flow path of the blowoff flow amount control valve 125. The other side of the blowoff flow amount control valve 125 connected with or cut from the flow path by the valve connects with one end of the blowoff gas supply pipe 123. The other end of the blowoff gas supply pipe 123 connects with a blowoff gas supply flow path 76 provided on the joint member 27 of the pad holder 23. The blowoff gas supply unit 120 has four sets of the blowoff gas supply source 121, the blowoff gas supply pipe 122, the blowoff flow amount control valve 125, and the blowoff gas supply pipe 123. Each set of the blowoff gas supply source 121, the blowoff gas supply pipe 122, the blow off flow amount control valve 125, and the blowoff gas supply pipe 123 are connected with the corresponding one of the four blowoff holes 86 of the suction hold hand 20.

The open/close drive source of the blowoff flow amount control valve 125 is electrically connected with the suction hold control unit 110. The suction hold control unit 110 is electrically connected with the work feeding and removing device control unit 39. The suction hold control unit 110 controls the open/close drive source according to control signals received from the work feeding and removing device control unit 39 to achieve control over supply, stop, and supply amount adjustment of the blowoff gas by the blowoff flow amount control valves 125. The blowoff flow amount control valves 125 correspond to a flow amount control valve.

The device attachment unit 24 of the suction hold hand 20 is a substantially cylindrical component which has a large-diameter attachment hole 41 inside the upper half part, and a small-diameter attachment hole 42 inside the lower half part. The attachment hole 41 and the attachment hole 42 are coaxially disposed. The attachment hole 41 functions as a portion through which the suction hold hand 20 is attached to the hand hold mechanism 34 of the robot mechanism 30. An attachment 72 of the joint member 27 is inserted into the attachment hole 42.

The hand hold mechanism 34 and the device attachment unit 24 are fixed to each other by fastening a fixing screw into an upper screw hole 43 provided on the device attachment unit 24 at a position corresponding to the portion of the hand hold mechanism 34 inserted into the attachment hole 41. The device attachment unit 24 and the joint member 27 are fixed to each other by fastening a fixing screw into a lower screw hole 44 provided on the device attachment unit 24 at a position corresponding to the attachment 72 inserted into the attachment hole 42.

The joint member 27 of the pad holder 23 has the attachment 72 and a vertical portion 71. The attachment 72 having a cylindrical shape stands on one end top surface of the vertical portion 71 having a substantially prism shape such that the center axis of the attachment 72 is located substantially at the same position as the center of the approximately prism shape of the vertical portion 71. A flat portion 72a produced by cutting a part of the side surface of the attachment 72 having a cylindrical shape is disposed in such a position that the fixing screw engaging with the lower screw hole 44 contacts the flat portion 72a. The joint member 27 is attached to the device attachment unit 24 by inserting the attachment 72 into the attachment hole 42 of the device attachment unit 24 and fastening the fixing screw into the lower screw hole 44. A pedestal 79 having a substantially square shape whose corners are beveled projects from the end surface of the vertical portion 71 on the side opposite to the side from which the attachment 72 projects. The concave portion of the work guide 26 engages with the pedestal 79 to be positioned and fixed thereto.

The suction gas supply flow path 73 and the blowoff gas supply flow path 76 are provided within the vertical portion 71.

The suction gas supply flow path 73 is an L-shaped flow path connecting with the suction gas supply pipe 103 and with the turning flow generating chambers 181 of the suction pads 21. The suction gas supply flow path 73 has a horizontal flow path 74 and a vertical flow path 75. The horizontal flow path 74 which opens to the side surface of the substantially prism-shaped vertical portion 71 extends substantially perpendicularly to the side surface of the vertical portion 71. The opening of the horizontal flow path 74 connects with the suction gas supply pipe 103. The vertical flow path 75 whose one end opens to the substantially center position of the surface of the pedestal 79 extends substantially perpendicularly to the surface of the pedestal 79. The opening of the vertical flow path 75 connects with a suction gas hole 64 of the work guide 26 engaging with the pedestal 79. The ends of the horizontal flow path 74 and the vertical flow path 75 on the side opposite to the open ends are joined with each other to form the substantially L-shaped suction gas supply flow path 73.

The blowoff gas supply flow path 76 is a substantially L-shaped flow path which connects with the blowoff gas supply pipe 123 and the blowoff holes 86 of the head case 51. The blowoff gas supply flow path 76 has a horizontal flow path 77 and a vertical flow path 78. The horizontal flow path 77 which opens to the side surface of the substantially prism shaped vertical portion 71 extends substantially perpendicularly to the side surface of the vertical portion 71. The opening of the horizontal flow path 77 connects with the blowoff gas supply pipe 123. The vertical flow path 78 whose one end opens to the vicinity of a corner of the substantially square surface of the pedestal 79 extends substantially perpendicularly to the surface of the pedestal 79. The opening of the vertical flow path 78 connects with a blowoff gas hole 66 of the work guide 26 engaging with the pedestal 79. The ends of the horizontal flow path 77 and the vertical flow path 78 on the side opposite to the open ends are joined with each other to form the substantially L-shaped blowoff gas supply flow path 76. The vertical portion 71 has the four gas supply flow paths 76 each of which is connected with the corresponding one of the four blowoff holes 86 formed at the four corners of the head case 51.

The work guide 26 has a guide main body 61 whose diagonally located two corners expand from a substantially square thick plate in the direction of the plate surface, and four guide projections 62 projecting from the tips of the expanded portions of the plate surface. The guide main body 61 and the guide projections 62 are formed integrally with each other.

The surface of the guide main body 61 on the side opposite to the side where the guide projections 62 are formed has a seat as a recess into which the pedestal 79 of the vertical portion 71 is inserted. The pedestal 79 formed on the end surface of the joint member 27 (the vertical portion 71) coaxially engages with the seat to be fixed thereto.

The blowoff gas holes 66 penetrating the guide main body 61 are formed at the positions corresponding to the four vertical flow paths 78 open to the pedestal 79 such that the vertical flow paths 78 and the blowoff gas holes 66 communicate with each other.

The four guide projections 62 are disposed at such relative positions as to contact the four sides of a substantially rectangular or square workpiece in the vicinity of a pair of diagonally positioned two corners of the workpiece. More specifically, the four guide projections 62 are disposed in such positions as to locate the workpiece overlapping with the guide main body 61 in the following condition. One corner of the workpiece is positioned between the adjoining two guide projections 62, and each of the two sides forming the corner is almost brought into contact with the corresponding one of the guide projections 62. Also, the corner of the workpiece diagonally facing the one corner is positioned between the other adjoining two guide projections 62, and each of the two sides forming the corner is almost brought into contact with the corresponding one of the guide projections 62. The four guide projections 62 regulate movement of the substantially rectangular or square workpiece in the surface direction of the guide main body 61. A workpiece having different size or a different planar shape can be sucked and held by varying the positions of the four guide projections 62.

The suction hold head 25 discussed above is supported by the work guide 26 in the vertical direction. Each of the four blowoff gas holes 66 formed on the work guide 26 communicates with the corresponding one of the four blowoff gas holes 56 formed on the cover case 52 of the suction hold head 25 under the condition where the suction hold head 25 is supported by the work guide 26 in the vertical direction. Also, the suction gas hole 64 formed approximately at the center of the work guide 26 communicates with the suction gas hole 54 formed approximately at the center of the cover case 52 under the condition where the suction hold head 25 is supported by the work guide 26 in the vertical direction.

The operations of the respective components of the suction hold hand 20 at the time of suction hold and hold release of the workpiece performed by the suction hold hand 20 are now explained.

When the workpiece is sucked and held by the suction hold hand 20, the suction gas supply source 101 of the suction gas supply unit 100 is actuated such that compressed air can be supplied. Compressed air is supplied from the suction gas supply source 101 through the suction gas supply pipe 102, and passes through the suction gas supply pipe 103, the suction gas supply flow path 73 of the joint member 27, the suction gas hole 64 of the work guide 26, the suction gas hole 54 of the cover case 52, and the compressed air groove 88 of the head case 51 to the suction pads 21 by opening the suction flow amount control valve 105. The compressed air introduced to the suction pads 21 flows from the chamber flow paths 185 communicating with the long sub compressed air grooves 85a or the short sub compressed air grooves 85b of the compressed air groove 88, and then flows from the injection gas flow paths 183 into the turning flow generating chambers 181. Since the flow paths of the turning flow generating chambers 181 have reduced cross-sectional areas, the compressed air from the injection gas flow paths 183 is injected into the turning flow generating chambers 181 at high speed. As described above, the compressed air having entered the turning flow generating chambers 181 flows along the inner circumferential surfaces 184 of the turning flow generating chambers 181. Thus, high-speed turning flow indicated by the arrow a in FIG. 5A is generated by the high-speed injection of the compressed air. In this case, negative pressure is produced in the turning flow generating chambers 181 by the high-speed turning flow. As a result, a force for pressing the workpiece toward the suction pads 21 is given to the workpiece facing the openings of the turning flow generating chambers 181, and thus the workpiece is sucked toward the suction pads 21. The compressed air turning within the turning flow generating chambers 181 flows from the openings of the turning flow generating chambers 181 and comes between the suction hold surfaces 182 and the workpiece. Thus, a clearance is produced between the workpiece and the suction hold surfaces 182 (the suction pads 21).

On the other hand, the blowoff gas supply sources 121 of the blowoff gas supply unit 120 are actuated such that compressed air can be supplied. compressed air is supplied from the blowoff gas supply sources 121 through the blowoff gas supply pipes 122, and passes through the blowoff gas supply pipes 123, the blowoff gas supply flow paths 76 of the joint member 27, the blowoff gas holes 66 of the work guide 26, the blowoff gas holes 56 of the cover case 52 to be supplied to the blowoff holes 86 of the head case 51 by opening the blowoff flow amount control valves 125. Since the blowoff holes 86 are stepped holes each of which has a reduced cross-sectional area on the outer surface side of the head case 51 (the surface on the side engaging with the suction pads 21), the compressed air supplied to the blowoff holes 86 is injected from the outer surface of the head case 51 as indicated by the arrow b in FIG. 5A. The injected air contacts the workpiece sucked toward the suction pads 21, thereby securely maintaining the clearance between the workpiece and the suction hold surfaces 182 (the suction pads 21). The size of the clearance can be controlled by adjusting the flow amount of the compressed air through the control of the opening of the blowoff flow amount control valves 125.

The blowoff gas supply unit 120, the blowoff gas supply flow paths 76, the blowoff gas holes 66, the blowoff gas holes 56, and the blowoff holes 86 correspond to a gas blowoff device.

Since the blowoff flow amount control valve 125 and the flow path for the compressed air are provided for each of the four blowoff holes 86, the flow amount of the compressed air can be separately controlled for each of the four blowoff holes 86. In this case, the inclination of the sucked and held workpiece to the head case 51 can be adjusted by separately controlling each flow amount of the four blowoff holes 86.

Most of the force given to the workpiece by the air from the suction pads 21 and the blowoff holes 86 is a force substantially perpendicular to the outer surface of the head case 51. As explained above, the force acting on the workpiece is a force in the vertical direction according to the work feeding and removing device in this embodiment. In this case, the workpiece sucked and held by the suction hold hand 20 is scarcely subject to a limiting force in any direction crossing the vertical direction, and thus can be moved easily. The guide projections 62 of the work guide 26 are provided to limit this movement and prevent separation of the workpiece from the suction hold hand 20. When the horizontal position of the workpiece sucked and held by the suction hold hand 20 is inclined, the workpiece shifts to the lower position by its own weight. Thus, the workpiece can be moved in the lower direction by tilting the workpiece through the flow amount control of the compressed air supplied to the blowoff holes 86. Accordingly, the workpiece can be properly positioned with respect to the suction hold hand 20 by shifting the workpiece until contact with the particular guide projections 62.

### Other Suction Hold Hand

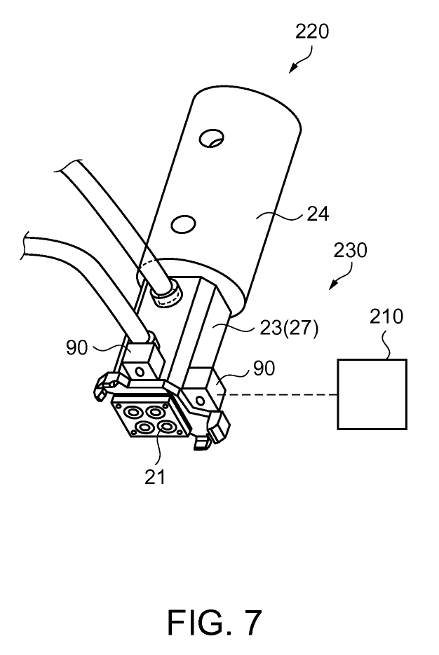

A suction hold hand 220 having structure different from that of the suction hold hand 20 is now explained with reference to FIG. 7. FIG. 7 is a perspective view illustrating the external appearance of the general structure of the pad holder 23 and its surroundings of the suction hold hand 220.

The suction hold hand 220 is different from the suction hold hand 20 in that the suction hold hand 220 includes distance detection devices 90 and a suction hold control unit 210 having a function for controlling the blowoff flow amount control valves 125 and the like based on the detection results of the distance detection devices 90 in addition to the function of the suction hold control unit 110 of the suction hold hand 20.

As illustrated in FIG. 7, the distance detection devices 90 are fixed to the side surface of the joint member 27 of the pad holder 23. The suction hold hand 220 has the four distance detection devices 90 (the two distance detection devices 90 behind the joint member 27 are not shown in FIG. 7). The detection surfaces of the distance detection devices 90 face in the air blowoff direction of the blowoff holes 86 such that the distance between the detection surfaces and an object lying in this direction can be detected. The distance detection devices 90 detect the size of the clearance between the suction pads 21 and the workpiece by measuring the distance between the detection surfaces and the workpiece sucked and held by the suction hold hand 220. The clearance between the suction pads 21 and the workpiece is adjusted to an appropriate size by controlling the flow amount of the compressed air through adjustment of the opening of the blowoff flow amount control valves 125 based on the detection results.

Since the suction hold hand 220 has the four distance detection devices 90, the distance between the workpiece and the suction hold surfaces 182 of the suction pads 21 in the vertical direction can be detected at the four points of the workpiece. By this method, the inclination of the workpiece to the suction hold surfaces 182 (more accurately, the suction hold surface formed by the four suction hold surfaces 182 for holding the workpiece) can be detected. In this case, the inclination of the workpiece to the suction hold surfaces 182 can be corrected, or the workpiece can be tilted in arbitrary directions, by separately controlling each flow amount of the blowoff flow amount control valves 125.

The distance detection devices 90 correspond to a measuring unit, and the suction hold control unit 210 corresponds to a flow amount balance control unit.

This embodiment can provide the following advantages.

(1) The four blowoff holes 86 are formed at the four corners of the head case 51. According to this structure, the compressed air supplied from the blowoff gas supply unit 120 can be released from the outer surface side of the blowoff holes 86 and applied to the sucked surface of the sucked and held workpiece. Thus, the clearance between the workpiece and the suction hold surfaces 182 can be securely maintained by the force acting on the workpiece such that the workpiece can be separated from the suction hold surfaces 182.

(2) The blowoff gas supply unit 120 has the blowoff flow amount control valves 125 containing the valves capable of opening and closing the flow paths of the compressed air and controlling the flow amount of the compressed air. The flow amount of the compressed air supplied to the blowoff holes 86 can be controlled by using the blowoff flow amount control valves 125. The clearance between the workpiece and the suction hold surfaces 182 can be adjusted by controlling the flow amount of the compressed air supplied to the blowoff holes 86.

(3) The blowoff gas supply unit 120 has the four blowoff flow amount control valves 125 each of which has the valve capable of opening and closing the flow path of the compressed air and controlling the flow amount of the compressed air in correspondence with the four blowoff holes 86. In this case, each flow amount of the compressed air supplied to the corresponding blowoff hole 86 can be individually controlled by separately using each of the blowoff flow amount control valves 125. Thus, the clearance between the workpiece and the suction hold surfaces 182 can be locally adjusted by separately controlling each flow amount of the compressed air supplied to the respective blowoff holes 86. Accordingly, the position of the workpiece with respect to the suction hold surfaces 182 can be properly adjusted.

(4) The four suction pads 21 are fixed to the central area of the head case 51, and the blowoff holes 86 are provided at the peripheral four corners of the head case 51. The four turning flow generating chambers 181 are positioned inside a quadrangle formed by the four blowoff holes 86. In this case, the point of application of the suction force produced by the four turning flow generating chambers 181 is also positioned inside the quadrangle formed by the four blowoff holes 86. Similarly, the point of application of the combined pressing force produced by the compressed air supplied from the four blowoff holes 86 and the like is positioned substantially at the center position of the quadrangle formed by the four blowoff holes 86. Since the points of application of the suction force and the pressing force acting on the workpiece are close to each other, the moment produced by the positional difference between the suction force and the pressing force is small. Accordingly, inclination of the sucked surface of the workpiece to the suction hold surfaces 182 can be reduced.

(5) The suction hold hand 220 can measure the distance between the suction pads 21 and the sucked and held workpiece by using the distance detection devices 90.

(6) The suction hold hand 220 has the suction hold control unit 210 which controls the blowoff flow amount control valves 125 and the like based on the detection results of the distance detection devices 90. Thus, the distance between the suction pads 21 and the sucked and held workpiece can be adjusted to an appropriate size based on the measured distance between the suction pads 21 and the sucked and held workpiece.

(7) The suction hold hand 220 has the four distance detection devices 90. Thus, the distance between the sucked and held workpiece and the suction hold surfaces 182 of the suction pads 21 in the areas opposed to the distance detection devices 90 in the vertical direction can be measured by the respective distance detection devices 90. Accordingly, the inclination of the workpiece to the suction hold surfaces 182 can be detected by measuring the distance between the four points of the workpiece and the suction hold surfaces 182.

Moreover, each flow amount of the compressed air at the blowoff flow amount control valves 125 can be individually controlled by separately using each of the blowoff flow amount control valves 125. Thus, the inclination of the workpiece to the suction hold surfaces 182 can be corrected, or the workpiece can be tilted in an arbitrary direction, by separately using each of the blowoff flow amount control valves 125 for flow amount control based on the detection results.

The invention is not limited to the preferred embodiment described herein with reference to the appended drawings, but maybe practiced otherwise without departing from the scope of the invention. For example, the following modifications may be made.

### Modified Example 1

While the head case 51 has the four blowoff holes 86 in this embodiment, the number of the blowoff holes is not limited to four. The number of the blowoff holes may be arbitrarily determined as long as the blowoff holes are disposed at such positions that the suction force and the pressing force produced by blowoff gas supplied from the blowoff holes can be balanced.

### Modified Example 2

While the suction hold hand 20 has the four suction pads 21 in this embodiment, the number of the suction pads provided on the suction hold hand is not limited to four. The number of the suction pads of the suction hold hand may be arbitrarily determined as long as a suction hold force appropriate for the size and weight of the hold target to be sucked and held can be provided.

### Modified Example 3

While the blowoff gas supply unit 120 included in the gas blowoff device has the blowoff flow amount control valves 125 capable of controlling the flow amount of the compressed air as flow amount control valves in this embodiment, the flow amount control valves of the gas blowoff device may be eliminated. In this case, the gas supply device maintains constant pressure of the supplied gas to keep the flow amount constant.

### Modified Example 4

While the suction hold hand 20 has the four blowoff gas supply sources 121 in correspondence with the four blowoff holes 86 in this embodiment, the blowoff gas supply source is not required for each blowoff hole. It is possible to provide a common gas supply source for the plural blowoff holes.

### Modified Example 5

While the distance detection devices 90 as the measuring unit are attached to the joint member 27 of the suction hold hand 220 in this embodiment, the measuring unit is not required to be formed integrally with the suction hold hand. The measuring unit can detect the inclination of a hold target by measuring the hold target from the side opposite to the side facing the suction hold surface of the suction hold hand even when the hold target is small enough to be hidden by a component corresponding to the suction hold head 25.

### Modified Example 6

While the work feeding and removing device 10 as the carrying device having the suction hold hand includes the suction hold hand 20, the work feeding and removing arm 31, the machine stand 38, and the work feeding and removing device control unit 39 in this embodiment, the carrying device is not required to have a unit for holding and moving the suction hold hand 20 and the like such as the work feeding and removing arm 31 and the machine stand 38. For example, the carrying device may be a device which supports the suction hold hand 20 by a manually movable simple support member.

### Modified Example 7

While the suction hold hand 220 as the suction hold hand has the four distance detection devices 90 as the measuring unit in this embodiment, the number of the measuring unit provided on the suction hold hand is not limited to four. The measuring unit can measure the distance between a part of the hold target and the suction hold surface even when only one measuring unit is provided. When three or more measuring units are provided, the measuring units can detect the inclination of the hold target to the suction hold surface by measuring the distance between three or more points of the hold target and the suction hold surface.

### Modified Example 8

While the suction gas supply unit 100 has the suction flow amount control valve 105 for opening and closing the flow path of the compressed air in this embodiment, the device for opening and closing the flow path or controlling the flow amount of the gas can be eliminated. In this case, the supply source of the suction gas performs operation for supply and stop of the suction gas and for controlling the supply amount.

### Modified Example 9

While the suction gas supply source 101 and the blowoff gas supply sources 121 are separately provided on the suction gas supply unit 100 and the blowoff gas supply unit 120, respectively, in this embodiment, the suction gas supply source and the blowoff gas supply sources may be provided as a common supply source. When the suction gas supply source and the blowoff gas supply source are constituted by a common unit, it is preferable that a device for opening and closing the flow path and controlling the flow amount of the gas such as the suction flow amount control valve 105 and the blowoff flow amount control valves 125 is equipped.

### Modified Example 10

According to this embodiment, the clearance between the workpiece and the suction hold surfaces 182 can be locally controlled by separately adjusting each flow amount of the compressed air supplied to the respective blowoff holes 86. By this method, the position of the workpiece with respect to the suction hold surfaces 182 can be controlled as explained above. In addition, the workpiece can be tilted to the suction hold surface disposed substantially horizontal. The workpiece sucked and held by the suction hold hand is suspended from the suction hold hand and thus is scarcely subject to a limiting force in a direction parallel with the suction hold surface. When the workpiece is tilted, an urging force for shifting the workpiece downward by the gravity acts on the workpiece. In this case, the workpiece scarcely subject to the limiting force in the direction parallel with the suction hold surface moves in the direction of the vertically lower end of the tilted workpiece. As a result, the workpiece comes to contact regulating members such as the guide projections 62. By this method, the workpiece can be disposed at such a position as to contact the regulating members.

The entire disclosure of Japanese Patent Application No. 2009-102743, filed Apr. 21, 2009 is expressly incorporated by reference herein.

What is claimed is:

1. A suction hold hand which sucks and holds a hold target without contact by using negative pressure produced at a central portion of turning flow of gas generated in a turning flow generating chamber and gas flowing from the end to the side of the turning flow generating chamber, comprising:
a suction pad having a suction hold surface to which a suction blowoff hole of the turning flow generating chamber opens; and
a gas blowoff device which has a plurality of blowoff holes disposed to oppose to a sucked surface substantially continuous to a surface of the hold target sucked by the suction pad to face the suction hold surface, the blowoff holes being located in such positions as to apply compressed gas to the sucked surface.

2. The suction hold hand according to claim 1, wherein the gas blowoff device has a flow amount control valve which can control each of the flow amounts of the gas supplied to the plural blowoff holes.

3. The suction hold hand according to claim 1, wherein:
the gas blowoff device has three or more of the blowoff holes; and
three or more of the blowoff holes are disposed in such positions that the center of the suction blowoff hole is positioned inside a polygon formed by connecting the centers of the blowoff holes.

4. The suction hold hand according to claim 1, further comprising a measuring unit which measures the distance between a part of the hold target and the suction hold surface.

5. The suction hold hand according to claim 4, further comprising a flow amount balance control unit which separately adjusts each of the flow amounts of the gas supplied to the blowoff holes by controlling the flow amount control valve according to the distance between each part of the hold target and the suction hold surface measured by the measuring unit.

6. A suction hold method which sucks and holds a hold target without contact via a suction pad having a suction hold surface by using negative pressure produced at a central portion of turning flow of gas generated in a turning flow generating chamber and gas flowing from a suction blowoff hole of the turning flow generating chamber to the suction hold surface to which the suction blowoff hole opens, comprising:
supplying compressed gas to a plurality of blowoff holes of a gas blowoff device, and the blowoff holes are disposed to a position opposed to a sucked surface substantially continuous to a surface of the hold target, to apply the compressed gas to the sucked surface when the hold target is sucked and held by the suction pad and positioned in such a position as to face the suction hold surface; and
sucking the hold target toward the suction hold surface by supplying the compressed gas to the turning flow generating chamber.

7. The suction hold method according to claim 6, further comprising controlling the flow amount of the compressed gas applied to the sucked surface in supplying compressed gas.

8. The suction hold method according to claim 7, wherein:
the gas blowoff device has three or more of the blowoff holes; and
three or more of the blowoff holes are disposed in such positions that the center of the suction blowoff hole is positioned inside a polygon formed by connecting the centers of the blowoff holes.

9. The suction hold method according to claim 7, further comprising measuring the distance between a part of the hold target and the suction blowoff hole.

10. The suction hold method according to claim 9, further comprising separately adjusting each of the flow amounts of the gas supplied to each of the blowoff holes according to the measured distance between each part of the hold target and the suction hold surface.

11. A carrying device, comprising:
a holding unit which sucks and holds a carrying target without contact by using negative pressure produced at a central portion of turning flow of gas generated in a turning flow generating chamber and gas flowing from the end to the side of the turning flow generating chamber such that the carrying target held by the holding unit can be carried,
wherein the holding unit includes
a suction pad having a suction hold surface to which a suction blowoff hole of the turning flow generating chamber opens, and
a gas blowoff device which has a plurality of blowoff holes disposed to oppose to a sucked surface substantially continuous to a surface of the carrying target sucked by the suction pad to face the suction hold surface, the blowoff holes being located in such positions as to apply compressed gas to the sucked surface.

12. The carrying device according to claim 11, wherein the gas blowoff device has a flow amount control valve which can control each of the flow amounts of the gas supplied to the plural blowoff holes.

13. The carrying device according to claim 11, wherein:
the gas blowoff device has three or more of the blowoff holes; and
three or more of the blowoff holes are disposed in such positions that the center of the suction blowoff hole is positioned inside a polygon formed by connecting the centers of the blowoff holes.

14. The carrying device according to claim 11, further comprising a measuring unit which measures the distance between a part of the carrying target and the suction hold surface.

15. The carrying device according to claim 14, further comprising a flow amount balance control unit which separately adjusts each of the flow amounts of the gas supplied to the blowoff holes by controlling the flow amount control valve according to the distance between each part of the carrying target and the suction hold surface measured by the measuring unit.

16. The carrying device according to claim 14, wherein the measuring unit is formed integrally with the suction pad of the holding unit.

17. The carrying device according to claim 14, wherein the measuring unit is fixed separately from the suction pad of the holding unit.
